(19) United States
(12) Patent Application Publication
(10) Pub. No.: US 2017/0131416 A1
(43) Pub. Date: May 11, 2017

(54) METHOD AND SYSTEM TO DETECT UNDERGROUND INHOMOGENEITIES

(71) Applicant: JUVAL MANTEL, HAIFA (IL)

(72) Inventor: JUVAL MANTEL, HAIFA (IL)

(21) Appl. No.: 15/266,098

(22) Filed: Sep. 15, 2016

Related U.S. Application Data
(60) Provisional application No. 62/219,141, filed on Sep. 16, 2015.

(51) Int. Cl. G01V 1/00

(52) U.S. Cl. CPC G01V 1/003; G01V 2210/324

(57) ABSTRACT

A system and method for detecting underground inhomogeneities, the system including at least one transmitting transducer arranged to transmit pre-selected acoustic signals of at least 2 Watts into the ground; at least three receiving transducers disposed at a selected distance from the transmitting transducer and arranged to receive acoustic signals transmitted by the transmitting transducer and reflected by an inhomogeneity in the ground, one of the receiving transducers being disposed in proximity to the transmitting transducer; and a processor; each receiving transducer being coupled to the processor and arranged to transfer the received signals to the processor; the processor configured to process the received reflected acoustic signals and determine, from characteristics of the signals and from the selected distance between the transmitting transducer and the receiving transducer, at least one of: the existence of an underground inhomogeneity; the distance from the receiving transducer to the underground inhomogeneity; the direction from the receiving transducer to the underground inhomogeneity; the acoustic impedance of the underground inhomogeneity; and a signature of the underground inhomogeneity.

### RELATED APPLICATIONS

This application claims the benefit of U.S. provisional patent application No. 62/219,141, filed 16 Sep. 2015.

### FIELD OF THE INVENTION

The present invention relates to detection system and methods, in general and, in particular, to a method and system for detecting underground inhomogeneities.

### BACKGROUND OF THE INVENTION

Several methods for detecting underground inhomogeneities are known. For example, the electric field that exists above the Earth's surface contains information about the structure of underground inhomogeneities. Furthermore, a large underground inhomogeneity, such as a salt dome or cavity, is known to disturb the subsurface temperature field. Detection and knowledge of the magnitude of these disturbances is the objective of both near surface and deep borehole temperature surveys aimed at delineating the inhomogeneities. In addition, geophysical surveys have been conducted in order to ascertain the existence of underground passages. These surveys were conducted using dipole electromagnetic profiling (DEMP) and ground penetrating radar (GPR).

First introduced in 1999, the multichannel analysis of surface waves (MASW) method is one of the seismic survey methods evaluating the elastic condition (stiffness) of the ground for geotechnical engineering purposes. MASW first measures seismic surface waves generated from various types of seismic sources—such as a sledge hammer—analyzes the propagation velocities of those surface waves, and then finally deduces shear-wave velocity (Vs) variations below the surveyed area that is most responsible for the analyzed propagation velocity pattern of surface waves.

With conventional arrangements, the receivers also receive noise that travels through the air and the surroundings, as well as surface or Rayleigh waves, which confuse the results of deeper searches. Accordingly, it would be desirable to screen or filter out all this extra noise and misleading information in order to provide accurate location and description information of various inhomogeneities deep in the ground.

### SUMMARY OF THE INVENTION

The present invention relates to a method and system to detect the existence, direction and distance of underground inhomogeneities, such as rocks and other bodies or objects, underground water sources, and man0made structures, such as sewage lines, pipes, tunnels, etc. The method includes transmitting acoustic signals with optional acoustic screening (or masking) and/or directivity, and high sensitivity reception of their reflections in a coordinated way with optional acoustic screening and/or directivity. Optionally, the signals are filtered so as to remove surface waves, which provide information interfering with accurate detection of deep inhomogeneities. The signals can be coordinated with regard to time, power and/or the shape of the acoustic signals.

Thus, there is provided, according to the present invention, a system for detecting underground inhomogeneities, the system including at least one transmitting transducer arranged to transmit pre-selected acoustic signals of at least 2 Watts into the ground; at least three receiving transducers disposed at a selected distance from the transmitting transducer and arranged to receive acoustic signals transmitted by the transmitting transducer and reflected by an inhomogeneity in the ground, one of the receiving transducers being disposed in proximity to the transmitting transducer; and a processor; each receiving transducer being coupled to the processor and arranged to transfer the received signals to the processor; the processor configured to process the received reflected acoustic signals and determine, from characteristics of the signals and from the selected distance between the transmitting transducer and the receiving transducer, at least one of: the existence of an underground inhomogeneity; the distance from the receiving transducer to the underground inhomogeneity; the direction from the receiving transducer to the underground inhomogeneity; the acoustic impedance of the underground inhomogeneity; and a signature of the underground inhomogeneity.

There is also provided, according to the invention, a method for detecting underground inhomogeneities. The method includes for detecting underground inhomogeneities, the method including transmitting pre-selected acoustic signals of at least 2 Watts into the ground by at least one transmitting transducer; receiving acoustic signals transmitted by the transmitting transducer and reflected by an inhomogeneity in the ground in at least three receiving transducers disposed at a known distance from the transmitting transducer, one of the receiving transducers being disposed in proximity to the transmitting transducer; and processing the received reflected acoustic signals to determine characteristics of the signals and to calculate, from the characteristics and from the distance between the transmitting transducer and the receiving transducer, at least one of: the existence of an underground inhomogeneity; the distance from the receiving transducer to the underground inhomogeneity; the direction from the receiving transducer to the underground inhomogeneity; acoustic impedance of the underground inhomogeneity; and a signature of the underground inhomogeneity.

### BRIEF DESCRIPTION OF THE DRAWINGS

The present invention will be further understood and appreciated from the following detailed description taken in conjunction with the drawings in which:

FIG. 1 is a block diagram illustration of a system for passive or active detection of underground inhomogeneities constructed and operative in accordance with one embodiment of the present invention;

FIG. 2 is a schematic illustration of a method for passive or active detection of underground inhomogeneities in accordance with one embodiment of the present invention;

FIGS. 3a and 3b are schematic illustrations of transmitter and/or receiver transducer arrangements, according to various embodiments of the invention;

FIGS. 4a and 4b illustrate exemplary transmission rods according to the invention;

FIGS. 5a, 5b and 5c are schematic illustrations of exemplary transducer array configurations; and

FIGS. 6a and 6b illustrate exemplary screening elements for individual receivers, according to embodiments of the invention.

### DETAILED DESCRIPTION OF THE INVENTION

The present invention relates to a method and system to detect the existence of underground inhomogeneities, buried several meters to tens of meters deep, preferably 2-70 meters, such as rocks and other bodies or objects, underground water sources, and man-made structures, such as sewage lines, pipes, tunnels, water, human bodies, etc., and the direction and distance of the underground inhomogeneities from a sound source. This is accomplished by transmitting high pressure level sound waves by a transducer or transducer array into the ground and receiving the waves after they are reflected by inhomogeneities in the ground by a receiving transducer or transducer array associated with a filter element to filter out noise from surface waves. The method for active detection of underground inhomogeneities in the soil, or caused by underground bodies and structures, their depth, direction and distance, includes transmitting signals into the ground. The power of the signals determines the depth to which they are transmitted in the ground. Thus, while signals of 2 Watts are sufficient for a few meters, if it is desired to search around 50 to 70 meters, signals of at least 100 Watts are required.

The transmitted signals include both low frequency waves, e.g., 10-100 Hz, which travel deep through the ground but provide poor resolution, and high frequency waves, e.g., e.g., 100 Hz to 10 kHz, which do not travel so far but provide good resolution. Preferably, the transmitted signals are coordinated with optional acoustic screening (or masking) and/or directivity. The method further includes high sensitivity reception of the reflections of these acoustic signals, for example, at least one microG when using accelerometers and less for acoustic receivers, in a coordinated way with optional acoustic screening and/or directivity to screen noise from the air above the ground and filter out surface or Rayleigh waves. Masking or screening protects against noises which come from a different direction, of a different spectrum or/and time than desired. Directivity of transmission or reception concerns the distribution of transmitting or reception energy in every different direction in space and can be selected according to the required resolution and the desired directions of strongest transmission or reception. In other words, transmission can be of low frequency waves at low directivity, i.e., relatively equal transmission in many or all directions, and when a possible inhomogeneity is encountered, high frequency waves can be transmitted with high directivity, i.e., in the direction from which the earlier received waves indicated an inhomogeneity. The signals can be coordinated with regard to time, power and/or the shape of the acoustic signals.

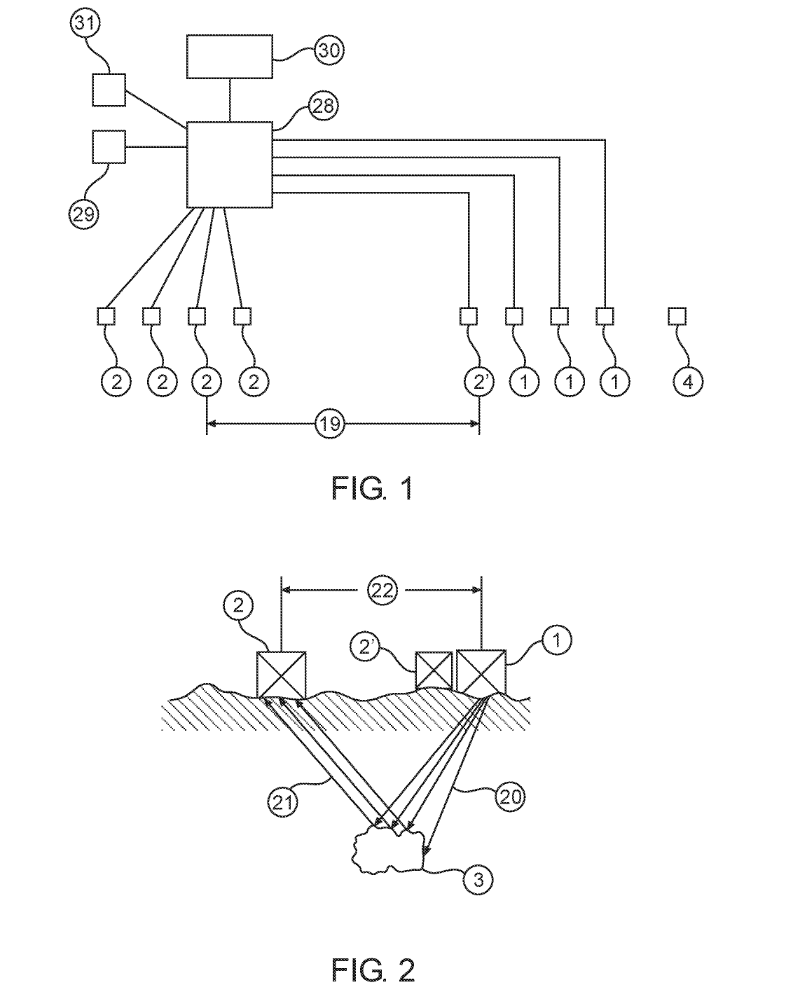

With reference to FIG. 1, there is shown a block diagram illustration of a system for active detection of underground inhomogeneities constructed and operative in accordance with one embodiment of the invention. The system includes at least one transmitting transducer 1, here shown as an array or plurality of transmitting transducers, arranged to transmit acoustic signals into the ground, and at least three receiving transducers 2, here shown as a plurality of receivers, arranged to receive reflected acoustic signals from the ground. The receiving transducers are preferably disposed at different depths and are disposed at known distances from the transmitting transducers. One of the receiving transducers 2′ is disposed in proximity to the transmitting transducer 1, relative to the distance of the other receiving transducers from the transmitting transducer, for example 0.5 meters and 20-30 meters. This permits calculation of the speed of sound through the ground in that location. Acoustic screening is preferably provided, although not required, for the receiving transducers to screen out noises travelling through the air above the ground which could interfere with the sounds collected through the ground. Most preferably, at least one receiving transducer is provided with acoustic screening.

In the illustrated embodiment, both the transmitting and receiving transducers are coupled to a processor 28 having a user interface (not shown), such as a keyboard, and a display 30. Peripheral equipment in a network, such as a data transmitter 31 and a data storage device 29, may also be provided. One of the receivers 2′ is placed adjacent the transmitters. The time differential between the signal from transmitter 1 to the close receiver 2′ and from transmitter 1 to the more distant receivers 2, together with the distance between them, permits the processor to calculate the speed of the waves. The time differentials of the returning waves are translated to distance differentials, relative to a direct line between the transmitter and the receivers. Alternatively, only the receiving transducers can be coupled to the processor, while the transmitting transducers 4 and other vibration sensors, such as piezo accelerometers, can be mechanically actuated and not connected to the processor.

The acoustic transmitting transducers 1 might include matched loudspeakers, piezo transducers, laser induced sound or filtered mechanical impulses, or any other transmitting device that can generate signals from 2 Watts. In order to reach depths of tens of meters, stronger signals are required, for example, at least 100 Watts. The sound receivers 2, 2′ might include capacitive microphones or other microphones, or a laser vibrometer, geophones, accelerometers, optical fibre sensors, such as Fizeau and other interferometers, or MEMs. The particular receivers selected in each location will depend on the conditions, for example, hydrophones can be used when there is water in the soil, optical means or microphones will be used when it is desired to avoid mechanical contact with the soil, and so forth.

According to some embodiments, the transmission of the acoustic signals can be accomplished by means of rods (for example, as shown at reference number 4 in FIG. 4a). The rods preferably include an integral spring (reference number 5 in rod 6 in FIG. 4a) with sufficient elasticity to generate the desired frequency and have a mass of, for example, several kilograms. The rods can be from about 1 to 30 meters long, depending on the depth of the search. The rods are activated to generate a selected frequency, such as a resonance frequency, filtered to a selected resolution, i.e., to filter out noises of different spectra than the desired signals, and/or to the requirements of the grid of the phased array 7 of transducers, described below. A suitable filter element may be associated with the transmitting transducers to perform this filtering. These rod or bars can be activated by a mechanical or electro-mechanical hammer, pre-pressed spring, pyrotechnic explosion, directed firearm fire, or by any conventional mechanical means. Alternatively, the rods or bars can be activated electronically, as by receiving an electric signal from the processor or other signaling device. Preferably, the rods are shielded by a layer of insulation, such as an acoustic insulation tube 23, seen in FIG. 4a. In this way, the transmitted sound waves will travel into the ground, rather than along the surface. Preferably, a hollow external sleeve 24, preferably insulated on the inside by an acoustically insulating pipe 23, is placed in a hole dug in the ground. A transmitting rod 4 or 6, is seated in insulation pipe 23 which insulates the rod from noises from the air and surface waves.

The transmitting and receiving transducers can be placed in an array to be used in a phased array arrangement, in which the distance between transducers is normally constant and correlated to the required spatial resolution and the selected working frequency. It will be appreciated that, since resolution requires high frequency of the transmitted signals, but depth of penetration requires low frequency, coordination is required to find the optimal combination in each different situation. For example, the transmitting transducers can be disposed with ½ meter to 10 meters between adjacent transducers, depending on the depth of the desired search. For a deeper search, the transducers must be disposed further apart from one another. For example, to search to 70 meters deep, the transducers should be about 10 meters apart from one another, while for shallower searches, the transducers will be disposed closer to one another.

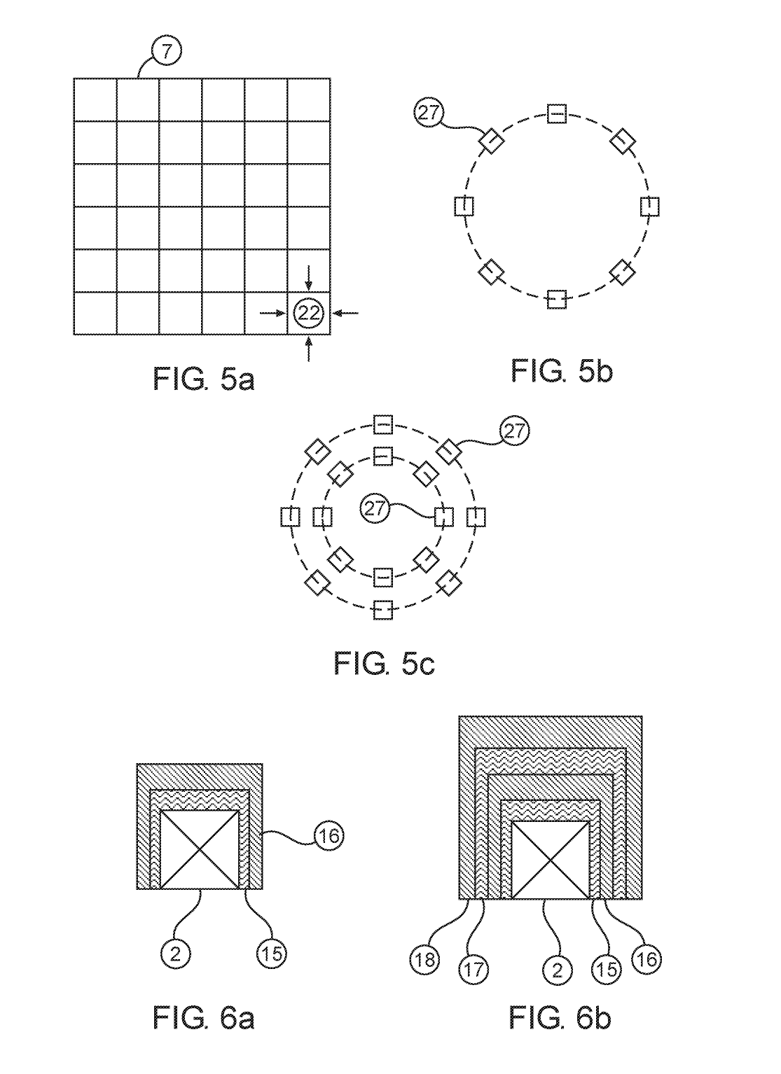

While various arrangements of receiving transducers and transmitting transducers can be utilized, the preferred arrangement is an array, most preferably, although not necessarily, in which each transducer is equidistant from the adjacent transducers. An array arrangement provides improved directivity of transmission and reception and increased sensitivity of the system. A few non-limiting examples of possible array configurations are shown in FIGS. 5a, 5b and 5c. FIG. 5a illustrates an orthogonal array 7 having a plurality of equidistant transducers 22. FIG. 5b illustrates another option, a circular array of transducers 27. FIG. 5c illustrates a further option, two coaxial circles of transducers 27. In this way, the processor can receive an indication of the order of detection of the reflected signals or transmitted signal beam and calculate, therefrom, the direction to the inhomogeneity. The transducers may be omni-directional or unidirectional and they may include beam-forming means to permit the creation of beams in selected directions. Buffers and amplifiers are provided, as required.

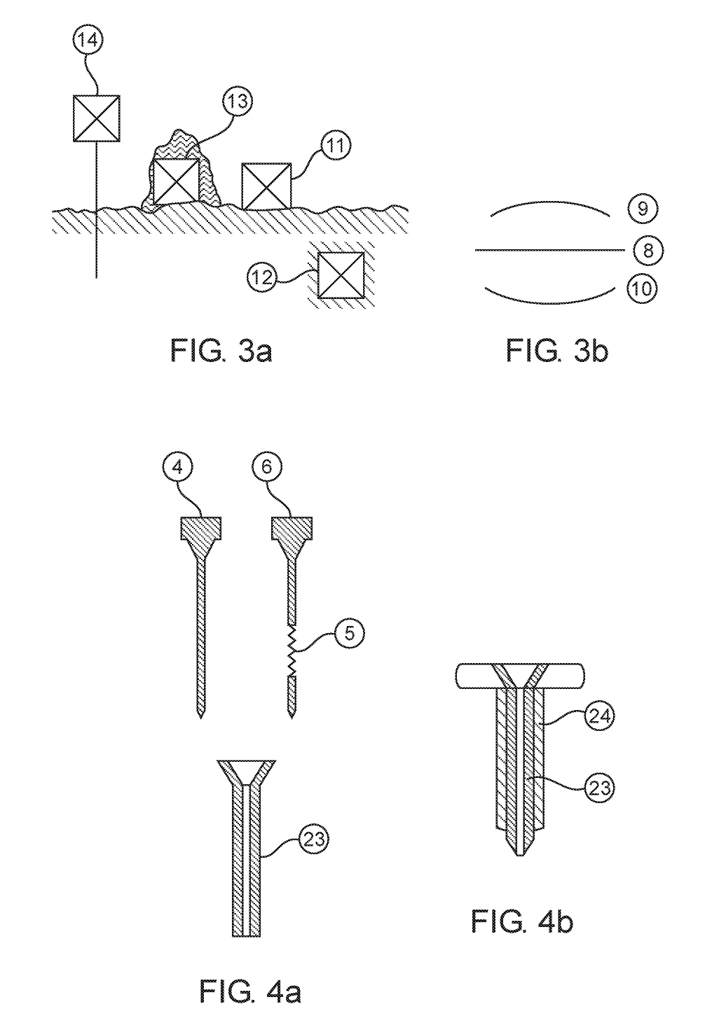

The transmitter and/or receiver arrangements may be disposed in a number of ways. They can be placed on the ground, as shown at reference numeral 11 in FIG. 3a, or buried in the ground, as shown at reference numeral 12 in FIG. 3a. When disposed above ground, they are typically covered by soil, sand and/or stones, as shown at reference numeral 13 in FIG. 3a, or may be disposed above the ground while mounted on a sound insulated inserting and stabilizing rod, as shown at reference numeral 14 in FIG. 3a. In the latter case, the rod may be a vibrator, shaker or a screened microphone, preferably acoustically insulated in all but a desired direction. Furthermore, the various transducers may be arranged as on a flat virtual surface 8, such as illustrated schematically in FIG. 4, or in a convex arrangement 9 or a concave arrangement 10, as in an orthogonal net or circular arrangement. Sound waves are transmitted by the transducer or transducer array into the ground and received after they are reflected by inhomogeneities in the ground. Preferably, one or more of the transducers are screened from outside sounds except in one direction. It will be appreciated that screening and filtering of unwanted signals can be accomplished by a filtering element in any suitable manner, including mechanically, electronically and/or during processing of the received signals.

According to some embodiments of the invention, each receiving transducer includes a hydrophone disposed in a vertical column of water extending into the ground. In these embodiments, the sound waves returning through the ground will be transferred to the water in the columns and received by the hydrophones.

Preferably, the receiver is acoustically screened from the local environment, exemplary embodiments of which are shown in FIGS. 6a and 6b. In FIG. 6a, the receiving transducer is screened by a sound absorbing layer 15, such as a soft and light-weight layer of mineral fiber, on which a housing 16, preferably a housing that reduces an acoustic signal that hits it by 40-70 dB, is placed, to provide additional acoustic screening. If necessary, a second sound absorbing layer 17 and another housing 18 can also be installed, as shown in FIG. 6b. It will be appreciated that if a strong, direct sound is transmitted, acoustic reception overflow can occur in the receiving transducer. In order to avoid this overflow in the receiving transducers, it may be desired to reduce temporarily the sensitivity of the receivers for a certain pre-defined time.

In preferred embodiments, the method includes using non-sinusoidal, overtone-rich transmissions, like square waves, in order to provide both travelling waves and deep waves. Thus, the fundamental frequency enables deep penetration into soils, while the harmonics permit wave travel to longer distances through the soil. These signals, including both a low basic frequency and one or more high frequencies (possibly harmonics) in the same signal, require coordination and are matched to the required resolution and/or phased array grid being used for a particular implementation.

Direction calculating means, preferably including a coarse direction calculator and a fine direction calculator, process the output of the receiving transducer array in order to determine the direction of origin of the received signals, which were reflected from an inhomogeneity in the ground. As stated above, the coarse direction calculator can include transmission of mainly lower frequency signals from one or a plurality of transducers or an array having little or no directivity, while the fine direction calculator can include transmission of mainly higher frequency signals from one or a plurality of transducers or an array having directivity selected according to the results of the coarse direction calculation. (See below.) Signal processing means are provided to analyze the received signals in order to determine the distance of the inhomogeneity from the receiving transducers array. The speed of sound and damping factors in the ground can be derived by using the distance between the transmitting transducer and the adjacent receiving transducer and their depths. This calculation is used to convert time delays of reflections in order to detect the distance of a detected inhomogeneity from the array.

Thus, the system of the present invention can be used to determine one or more of the following: the existence of an inhomogeneity, the distance from the receiver to the inhomogeneity, the direction from the receiver to the inhomogeneity. According to some embodiments, it is possible to also determine the acoustic impedance of the inhomogeneity and, even, its acoustic signature. All these can be calculated from the time differentials in transmitting and receiving the signals. If desired, a database storing characteristics of various types of inhomogeneities can be provided, coupled to a sound analyzing processor for inhomogeneity identification. This sound analyzing processor may be the same as, or different from, the signal processing means for distance determination. This sound analyzing processor analyzes the received signals and compares their characteristics to the characteristics of the various inhomogeneities stored in the database, to determine whether there is a match.

The method of the present invention is illustrated schematically in FIG. 2. A transmitting transducer 1 is disposed on or in the ground at a known distance 22 from at least two receiving transducers 2 in an area where it is suspected that an inhomogeneity exists. Another receiving transducer 2′ is disposed in proximity to the transmitting transducer 1 to permit calculation of the speed of sound through the ground in that area. A signal is transmitted from the transmitting transducer 1 to the receiving transducer 2′ to permit the processor 28 to determine the time between transmission and reception, which is a function of the acoustic impedance of the soil.

The transmitting transducer 1 transmits signals 20 into the ground, which are reflected 21 by an inhomogeneity 3 (if one exists) and received by receiving transducers 2. The received signals 21 are provided to the processor 28, shown in FIG. 1, which determines the existence of the inhomogeneity. Preferably, measurements are taken (i.e., receiving transducers 2 are disposed) at different depths to obtain best results. The system of the present invention can be used to discover inhomogeneities up to 70 meters underground. The processor 28 further processes the received reflected acoustic signals to determine whether the signals contain any pre-defined characteristics, which can indicate characteristics of the inhomogeneity. The processor then calculates, using these characteristics and the distance between the transmitting transducer and the receiving transducer, the distance and direction from the receiving transducer or transducers to the inhomogeneity.

A phased array method (when using multiple transducers) can be utilized to ensure a narrow beam of transmission and/or reception, which is selected according to the distances between the transducers in the transducer grid array. When the distance between the transducers is suited to multiples of λ/2(one half the wavelength)×cosin φ (angle to the perpendicular), it is possible to improve the directivity of transmission and/or reception.

The system can be arranged for operation in one of several modes, with regard to directivity—a measure of the directional characteristic of the sound source. In a first option, there is no directivity. In this case, there will be isophasing (i.e., the same phase for all) of the transmitting and receiving transducers. A second possibility is partial directivity. This can be implemented either as isophase transmission with directive reception or as directive transmission with isophase reception. A third possibility is full directivity. In this case, both transmission and reception will be phased (i.e., each transducer will transmit or receive at a different phase of the transmitted frequency). Full directivity is most appropriately utilized for fine direction calculations after receiving data from one of the partial directivity detections (which permitted a coarse direction calculation). This permits the user to focus on a direction from which an indication has already been received.

Preferably, the transmitted and received data and their combinations are correlated in various ways, e.g., cross-correlation function or time delay spectroscopy, or cross spectra and their combination to produce a non-dimensional correlation function. These correlations between transmission and reception permit a more accurate determination of the results regarding the inhomogeneity discovered.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for detecting underground inhomogeneities, the system comprising:
at least one transmitting transducer arranged to transmit pre-selected acoustic signals of at least 2 Watts into the ground;
at least three receiving transducers disposed at a selected distance from the transmitting transducer and arranged to receive acoustic signals transmitted by said transmitting transducer and reflected by an inhomogeneity in the ground, one of said receiving transducers being disposed in proximity to the transmitting transducer; and
a processor;
each said receiving transducer being coupled to said processor and arranged to transfer said received signals to the processor;
said processor configured to process said received reflected acoustic signals and determine, from characteristics of the signals and from said selected distance between the transmitting transducer and said receiving transducer, at least one of: the existence of an underground inhomogeneity; the distance from said receiving transducer to said underground inhomogeneity; the direction from said receiving transducer to said underground inhomogeneity; the acoustic impedance of said underground inhomogeneity; and a signature of said underground inhomogeneity.

2. The system according to claim 1, further comprising an acoustic screening element disposed around at least one receiving transducer to reduce reception of noise from air above the ground.

3. The system according to claim 2, wherein said acoustic screening element includes a housing and a sound absorbing layer disposed in the housing and disposed about the receiving transducer.

4. The system according to claim 1, further comprising a filtering element.

5. The system according to claim 4, wherein the filtering element is associated with the receiving transducer and arranged to filter out noise from surface waves received by the receiving transducer.

6. The system according to claim 4, wherein the filtering element is associated with the transmitting transducer and arranged to filter transmitted signals to create a selected transmission frequency in the transmitting transducer.

7. The system according to claim 1, wherein the transmitting transducers are configured and adapted to transmit simultaneously at least one frequency signal between 10-100 Hz and at least one frequency signal between 100 Hz to 10 kHz.

8. The system according to claim 1, wherein said at least one transmitting transducer includes a rod with an integral spring, that is activated to generate a selected frequency, filtered to a selected resolution.

9. The system according to claim 8, wherein said rod is disposed in an acoustic insulation tube which, in turn, is disposed in a hollow external sleeve disposed in a hole in the ground.

10. The system according to claim 1, wherein the at least one transmitting transducer includes a plurality of transmitting transducers and at least one selected from the group consisting of the transmitting transducers and the receiving transducers is arranged in an array.

11. The system according to claim 10, wherein said array is selected from the group including: an orthogonal array having a plurality of equidistant transducers, a circular array of transducers, and two coaxial circles of transducers.

12. A method for detecting underground inhomogeneities, the method comprising:
transmitting pre-selected acoustic signals of at least 2 Watts into the ground by at least one transmitting transducer;
receiving acoustic signals transmitted by said transmitting transducer and reflected by an inhomogeneity in the ground in at least three receiving transducers disposed at a known distance from the transmitting transducer, one of said receiving transducers being disposed in proximity to the transmitting transducer; and
processing said received reflected acoustic signals to determine characteristics of said signals and to calculate, from said characteristics and from said distance between said transmitting transducer and said receiving transducer, at least one of: the existence of an underground inhomogeneity; the distance from said receiving transducer to said underground inhomogeneity; the direction from said receiving transducer to said underground inhomogeneity; acoustic impedance of said underground inhomogeneity; and a signature of said underground inhomogeneity.

13. The method according to claim 12, further comprising disposing an acoustic screening element around at least one receiving transducer to reduce reception of noise from air above the ground.

14. The method according to claim 12, further comprising associating a filtering element with at least one of:
at least one of the receiving transducers, the filtering element arranged to filter out noise from surface waves received by the receiving transducer; and
the transmitting transducer, the filtering element arranged to filter transmitted signals to create a selected transmission frequency in the transmitting transducer.

15. The method according to claim 12, wherein the step of transmitting includes transmitting by a plurality of transmitting transducers, and further comprising arranging at least one selected from the group consisting of the transmitting transducers and the receiving transducers in an array, before said step of transmitting.

16. The method according to claim 12, wherein the transmitting transducers are configured and adapted to transmit simultaneously at least one frequency signal between 10-100 Hz and at least one frequency signal between 100 Hz to 10 kHz.

17. A method for making a system for detecting inhomogeneities underground, the method comprising:
disposing at least one transmitting transducer in contact with the ground arranged to transmit pre-selected acoustic signals of at least 2 Watts into the ground;
disposing at least two receiving transducers, arranged to receive acoustic signals transmitted by said transmitting transducer and reflected by an inhomogeneity in the ground, at a selected distance from the transmitting transducer;
disposing one receiving transducer in proximity to the transmitting transducer;
coupling each said receiving transducer to a processor for transferring said received signals to the processor; and
configuring said processor to process said received reflected acoustic signals and determine, from characteristics of the signals and from said selected distance between the transmitting transducer and said receiving transducer, at least one of: the existence of an underground inhomogeneity; the distance from said receiving transducer to said underground inhomogeneity; the direction from said receiving transducer to said underground inhomogeneity; the acoustic impedance of said underground inhomogeneity; and a signature of said underground inhomogeneity.

18. The method according to claim 17, wherein the step of disposing at least one transmitting transducer includes disposing a plurality of transmitting transducers, and further comprising arranging at least one selected from the group consisting of the transmitting transducers and the receiving transducers in an array, before said step of transmitting.

19. The method according to claim 17, wherein the transmitting transducers are configured and adapted to transmit simultaneously at least one frequency signal between 10-100 Hz and at least one frequency signal between 100 Hz to 10 kHz.

20. The method according to claim 17, further comprising associating a filtering element with at least one of:
at least one of the receiving transducers, the filtering element arranged to filter out noise from surface waves received by the receiving transducer; and
the transmitting transducer, the filtering element arranged to filter transmitted signals to create a selected transmission frequency in the transmitting transducer.
